(19) United States
(12) Patent Application Publication
(10) Pub. No.: US 2004/0058163 A1
(43) Pub. Date: Mar. 25, 2004

(54) Composite material

(76) Inventors: Peter Gansen, Seeburg (DE); Zeev Biro, Haan (DE); Adolf Stender, Duderstadt (DE)

Correspondence Address: HUSCH & EPPENBERGER, LLC, 401 MAIN STREET, SUITE 1400, PEORIA, IL, 61602, US

(21) Appl. No.: 10/618,558

(22) Filed: Jul. 11, 2003

Related U.S. Application Data
(63) Continuation-in-part of application No. 09/861,330, filed on May 18, 2001, now abandoned.

(30) Foreign Application Priority Data
May 18, 2000 (DE) 100 24 097.6-43

(51) Int. Cl. B32B 27/00; B32B 27/40

(52) U.S. Cl. 428/423.1

(57) ABSTRACT

The composite material made from a polyurethane gel and coarse-grain solid particles distributed therein may be made to be visually appealing and at the same time facilitates utilization of the properties of a polyurethane gel in a novel composite material. The particles consist of cork, foam, textile materials etc.

### CROSS REFERENCE TO RELATED APPLICATIONS

This application is a continuation-in-part of U.S. application Ser. No. 09/861,330 filed May 18, 2001, now ______, which claimed priority of German Application No. 100 24 097.6-43 filed on May 18, 2000.

### TECHNICAL FIELD OF THE INVENTION

The present invention relates generally to composite materials and, more particularly, to a composite material having a polyurethane gel.

Polyurethane gels are generally glass-clear materials having relatively high specific weight and which may be used for many applications. The gels are very elastic, impact-absorbing and shock-absorbing and can be deformed with good recovery values.

### DESCRIPTION OF THE RELATED ART

The gels claimed in patent specification EP 0 057 838 for avoiding decubitus are characterized by a low characteristic, that is by so-called undercuring. They are produced by reacting a polyisocyanate with long-chain polyols that are free of short-chain portions. These dimensionally stable gels comprised of polyurethane raw materials may be used as mattresses, mattress fillings, car seats and upholstered furniture. These polyurethane gels produced by undercuring are characterized by dimensional stability, excellent mechanical properties and tackiness. The tackiness is often perceived as an undesired characteristic. A tack-free surface may be achieved by surrounding the gel with different types of coatings.

Patent specification EP 0 511 570 discloses gels made from polyols and polyisocyanates having a low characteristic, which are produced from mixtures of long-chain and short-chain polyethers. These gels are more favorable in terms of processing technology and may be used as padding in shoes, on the seat surfaces of bicycle saddles, as supports for avoiding or preventing injuries, in facemasks and in padding below horse saddles, as well as various other applications.

The high weight and the high thermal capacity of seat cushions made from pure gel are generally regarded as a disadvantage. The high thermal capacity may lead to a cold seat feeling, since body heat is perceptibly removed to heat a cushion made from gel.

Lower weight fillers have been used in order to make these gels lighter. Fillers for plastics are generally known for use in various applications. For example, fillers may be used in plastic processing for improvement in mechanical properties, lowering of material costs and recycling of raw materials which otherwise can no longer be used. Different types of fillers are also relatively well known in the field of polyurethane chemistry. Specific fillers exist in various manifestations of materials made from polyurethanes. For example, melamine is used to improve flame resistance in soft foam. In the field of solid polyurethane elastomers—the so-called RIM products—glass is admixed to increase the strength of the reacting components. However, in the polyurethane gels, which are conventionally as clear as glass in pure form, the use of fillers leads to milky-cloudy appearance, which causes the material to appear visually unattractive.

The problem underlying the invention therefore consists in providing a material based on polyurethane gel, which minimizes the disadvantages described above, while preserving a visually attractive exterior. If possible, a reduction in the specific weight and a reduction in the cold feeling on body contact should also be achieved.

The present invention is directed to overcoming one or more of the problems set forth above.

### SUMMARY OF THE INVENTION

In one aspect of this invention, a composite material is disclosed. This composite material includes a polyurethane gel including coarse-grain solid particles distributed therein.

In another aspect of this invention, a molding made from a composite material is disclosed. This molding includes a polyurethane gel including coarse-grain solid particles distributed therein, wherein the diameter of the coarse-grain solid particles is in a range between 0.1 mm to 1 cm (0.003937 to 0.3937 in).

Still another aspect of this invention discloses a composite material. This composite material includes a polyurethane gel including coarse-grain solid particles distributed therein, wherein the diameter of the coarse-grain solid particles is in a range between 0.1 mm to 15 mm (0.003937 to 0.5906 in) utilized in a product selected from the group consisting of shoes uppers, shoe insoles, mattresses, seat supports, seat cushions or carpet back coatings.

The above aspects are merely illustrative examples of a few of the innumerable aspects associated with the present invention and should not be deemed an all-inclusive listing in any manner whatsoever.

### DETAILED DESCRIPTION

In accordance with an embodiment of the present invention there is provided a composite material made from a polyurethane gel and coarse-grain solid particles distributed therein, wherein the effective diameter of the solid particles is advantageously between 0.1 mm to 1 cm (0.003937 to 0.3937 in). The coarse-grain solid particles are selected from the group consisting of cork pieces, cork flour, wood pieces, wood chips, foam flakes, textile fibers and textile pieces. The composite material advantageously has an interesting, appealing appearance and at the same time good material properties which can be adjusted by shape, size and type of the particles. The visual appearance is determined by the coarse grain property of the incorporated particles, and specifically in a wide range, which can be determined by selecting the particles and the particle size. Since the particles can be recognized discretely, a visually novel gel composite material is produced.

The incorporation of lighter, i.e., density less than 1.5 kg per litre (12.517 lb per gal), and relatively coarse-grain solids is preferred.

Solid materials, which are produced from natural materials, such as cork for example, are preferred. The solid may reduce the thermal conductivity of the gel. Likewise, in most cases, the composite material has less tackiness. However, the visual attractiveness of the resulting composite material of the invention is particularly noteworthy.

The solids are characterized in that they have a particle size of 0.1 mm to about 15 mm (0.003937 to 0.5906 in). Hence, they are discrete particles, which can be differentiated by the eye. The composite material is visibly grainy. The geometry of the particles is generally irregular. The combination of the gel, which is as clear as glass in the basic state, with the irregular solid gives an attractive appearance to the composite material parts of the invention.

The diameter of the solid particles is more preferably between 1 and 5 mm (0.03937 to 0.1969 in).

The solid particles are added in such a quantity that they advantageously account for 5 to 90 percent by volume, but preferably 20 to 70 percent by volume, of the final product.

The solids used according to the invention are furthermore preferably of organic nature. Solids according to the invention may include, for example, cork pieces, cork flour, wood pieces, wood chips, foam flakes, textile fibers and textile pieces. The foams may be any type of foamed plastics and, in particular, polyurethane materials. They may also be solids of an open-celled and/or closed-celled nature.

The gel compositions of the polyurethane gel are preferably produced using raw materials of isocyanate functionality and functionality of the polyol component of at least 7.5. The polyol component of the gel may preferably consist of a mixture of

one or more polyols having hydroxyl numbers below 112, and

one or more polyols having hydroxyl numbers in the range 112 to 600,

wherein the weight ratio of component a) to component b) lies between 90:10 and 10:90, the isocyanate characteristic of the reaction mixture lies in the range from 15 to 60 and the mathematical product of isocyanate functionality and functionality of the polyol component is at least 6.

The polyol component may consist of one or more polyols having a molecular weight between 1,000 and 1,200 and an OH number between 20 and 112, wherein the mathematical product of the functionalities of the polyurethane-forming components is at least 5 or 6 (preferably 5.2) and the isocyanate characteristic lies between 15 and 60.

As isocyanate for polyurethane production of the formula Q(NCO)ₙ, wherein n represents 2 to 4 and Q denotes an aliphatic hydrocarbon radical having 6 to 18 C atoms, a cycloaliphatic hydrocarbon radical having 4 to 15 C atoms, an aromatic hydrocarbon radical having 6 to 15 C atoms or an araliphatic hydrocarbon radical having 8 to 15 C atoms, may be used.

The isocyanates may be used in pure form or in the form of conventional isocyanate modifications, but preferably urethanized, allophanatized or biuretized.

The invention also includes moldings made from the described composite material of the invention.

Preferred applications for the composite material in accordance with the present invention or moldings produced therefrom are shoe uppers, shoe insoles, foot rests, shoe soles, whole shoes, seat supports, mattresses, armchairs, seat cushions, bicycle saddles, carpet back coatings, and various damping elements. Many other applications are conceivable.

Properties, such as water uptake can be controlled specifically by selecting a suitable cover material or a suitable cover layer in combination with the appropriate filler. During water uptake, the positive water uptake properties of the pure gel are advantageous. For use as insole material, the wearer comfort or the mechanical property profile, may be adjusted specifically by varying the solids content and the hardness of the gel.

Combinations of the material according to the invention with foams, plastics, metals or other materials to form sandwich constructions are possible, given the adhesiveness of the material.

### EXAMPLES

The patterns of preferred embodiments of the invention were produced by mixing the polyol component with the solid and then adding the isocyanate. A conventional laboratory stirrer was used. The production of moldings by introducing the reacting polyol-solid-isocyanate mixture into an open or closed mold corresponds to conventional process technology. The continuous production of blocks made from the raw materials of the invention is likewise possible.

### Example 1

200 ml (6.763 fluid oz) of a trifunctional polyether polyol of OH number 36, which is treated with 0.05 wt. % of a catalyst (Coscat 83 from Messrs. Cosan Chemicals Co.), is mixed intensively with 200 ml (6.763 fluid oz) of a cork powder of average particle size of about 1 mm (0.03937 in). The resulting composition is then mixed with 27.6 g (0.9736 oz) of a modified aliphatic isocyanate (Desmodur KA 8114 from Bayer AG) by means of a laboratory stirrer. The reacting mixture is cast into a plate mould having the dimensions 20×20×1 cm (7.874×7.874×0.3937 in). After three minutes, the molding is removed from the mold. It has a similar appearance to a cork sole. The mechanical properties are as follows:

| Density: | 0.8 g/l (.01336 oz/pt) |
|---|---|
| Shore L: | 46 |
| Tensile strength: | 320 kPa |
| Extension at break: | 130% |

### Example 2

300 ml (10.14 fluid oz) of a trifunctional polyether polyol of OH number 36, which is treated with 0.05 wt. % of a catalyst (Coscat 83 from Messrs. Cosan Chemical Co.), is mixed intensively with 150 ml (5.072 fluid oz) of a cork powder of particle size averaging about 1 mm (0.03937 in). The reacting mixture is cast into a plate mold having the dimensions 20×20×1 cm (7.874×7.874×0.3937 in). After three minutes, the molding is removed from the mold. It has a similar appearance to a cork sole. The mechanical properties are as follows:

| Density: | 0.8 g/l (.0 1336 oz/pt) |
|---|---|
| Shore A: | 39 |
| Tensile strength: | 280 kPa |
| Extension at break: | 310% |

### Example 3

150 ml (5.072 fluid oz) of a trifunctional polyether polyol of OH number 36, which is treated with 0.05 wt. % of a catalyst (Coscat 38 from Messrs. Cosan Chemical Co.), is mixed intensively with 300 ml (10.14 fluid oz) of a cork powder of average particle size of about 1 mm (0.03937 in). The resulting composition is then mixed with 20.8 g (0.7337 oz) of a modified aliphatic isocyanate (Desmodur KA 8114 from Bayer AG) by means of a laboratory stirrer. The reacting mixture is cast into a plate mold having the dimensions 20×20×1 cm (7.874×7.874×0.3937 in). After three minutes, the molding is removed from the mould. It has a similar appearance to a cork sole. The mechanical properties are as follows:

| Density: | 0.7 g/l (.01168 oz/pt) |
|---|---|
| Shore A: | 56 |
| Tensile strength: | 440 kPa |
| Extension at break: | 118% |

### Comparative Example

400 ml (13.53 fluid oz) of a trifunctional polyether polyol of OH number 36, which was treated with 0.05 wt. % of a catalyst (Coscat 83 from Messrs. Cosan Chemical Co.), was mixed with 13 g (0.4586 oz) of a modified aliphatic isocyanate (Desmodur KA 8114 from Bayer AG) by means of a laboratory stirrer. The reacting mixture was cast into a plate mold having the dimensions 20×20×1 cm (7.874×7.874×0.3937 in). After three minutes, the molding was removed from the mold. It had a slightly milky appearance due to the air bubbles resulting during stirring. The mechanical properties were as follows:

| Density: | 1.1 g/l (.01836 oz/pt) |
|---|---|
| Shore A: | 34 |
| Tensile strength: | 263 kPa |
| Extension at break: | 437% |

The molding made from pure gel felt significantly colder.

The Shore hardness can be adjusted specifically by varying the cork portion. Furthermore, no negative effect on tensile strength can be established. The positive influence of the incorporated cork on the appearance of the molding and on the density should be emphasized.

Comparative Tests

Three molded specimens with the dimension 5×5×2.5 cm were tested. Pure gel (Sample 3), gel/cork (Sample 1), and latex/cork (Sample 2) were compared with one another. All three materials were adjusted to approximately the same shore L hardness. The product (specimen) made of latex/cork is a part of a sole cut out of a shoe sold by the company Birkenstock, which is commercially available. The pure gel product is a molded article made of Technogel. The gel is made of raw materials of the company Bayer. The component A of the gel used for Samples 1 and 3 consists of a 1:1 mixture of two polyols. The first polyetherpolyol has a hydroxyl number of 28, is propylene glycol-started and bases on propylene oxide with terminal ethylene oxide units. The second polyetherpolyol has a hydroxyl number of 35, is pentaerythritol-started, propylene oxide-extended and has terminal ethylene oxide units. Furthermore, the A component of the gel contains approximately 0.5 weight percentages of dibultyltin dilaurate. The A component of the gel is converted with the B component of the gel with a mixing ratio of 100:20. The B component is the aliphatic isocyanate Desmodur E-305 of Bayer AG. The effective diameter of the cork particles is between 1 mm and 3 mm (0.03937 in. and 0.1181 in.) approximately.

The conversion is realized in a low-pressure apparatus of the company Hilger & Kern, Mannheim. The molded specimen can be taken from the mold after approximately ten minutes. The molded specimen made of gel/cork is produced in the same way. Merely the mixing ratio from the A component to the B component is lower and is 100:15. Furthermore, cork is introduced into the reacting gel mixture by means of a screw.

The density in raw state, the shore L hardness, the loss factor and the storage modulus of the test samples were determined. The samples were measured according to the vibrometer method for determining the storage modulus and the loss factor according to DIN 53426. Deviating from said standard, the sample was not excited horizontally, but vertically according to BMW specification 1933613.3. The samples were excited with a digitally generated white noise.

Data Table

| | | | Storage | |
|---|---|---|---|---|
| | Raw State | Shore L | Modulus | |
| Sample No. | Density | Densimeter | kN/gm | Loss Factor |
| Sample 1 | 541.2 | 55 | 215.9 | 0.440 |
| Gel-cork (15 wt % | | | | |
| cork) | | | | |
| Sample 2 | 359.1 | 62 | 71.3 | 0.142 |
| Latex-cork (30 wt % | | | | |
| cork) | | | | |
| Sample 3 | 1047.2 | 53 | 134.0 | 0.289 |
| Gel | | | | |

The test results are interpreted as follows:

The single gel (Sample 3) has a loss factor of 0.289 at high density. In spite of the high weight, there is no extraordinary cushioning effect of this material. While the Cork/latex specimen is somewhat lighter, it provides, however, worse damping characteristics (i.e., loss factor 0.142).

Surprisingly, it was now found, that gel/cork has better damping characteristics (i.e., loss factor 0.440) compared to gel alone. Because of that, this material is perfectly suitable for any use, which requires a high loss factor; for example, insoles of shoes. Furthermore, this material is suitable for any use, which requires good shock absorption. Remarkable also is the increase of the solidity due to the incorporation of the cork. It is reasoned that this would be even more developed, if both gel variants had produced with an equal mixture ratio.

Other objects, features and advantages will be apparent to those skilled in the art. While preferred embodiments of the present invention have been illustrated and described, this has been by way of illustration and the invention should not be limited except as required by the scope of the appended claims.

What is claimed is:

1. A composite material comprising:
a polyurethane gel including coarse-grain solid particles selected from the group consisting of cork pieces, cork flour, wood pieces, wood chips, foam flakes, textile fibers and textile pieces distributed therein.

2. The composite material according to claim 1 having a loss factor greater than that of the polyurethane gel alone.

3. The composite material according to claim 1, wherein the effective diameter of the coarse-grain solid particles is in a range between 0.1 mm to 15 mm.

4. The composite material according to claim 3, wherein the diameter of the coarse-grain solid particles is in a range between 1 mm to 5 mm.

5. The composite material according to claim 1, wherein the coarse-grain solid particles are in a range of between 5 to 90 percent of the composite material's total volume.

6. The composite material according to claim 1, wherein the coarse-grain solid particles are in a range of between 20 to 70 percent of the composite material's total volume.

7. The composite material according to claim 1, wherein the polyurethane gel includes compositions produced from materials wherein the mathematical product of isocyanate functionality and functionality of the polyol component is at least 5.

8. The composite material according to claim 7, wherein the polyol component for producing the polyurethane gel includes of a mixture of one or more polyols having hydroxyl numbers below 112; and one or more polyols having hydroxyl numbers in the range 112 to 600, wherein the weight ratio of the one or more polyols having hydroxyl numbers below 112 to the one or more polyols having hydroxyl numbers in the range 112 to 600 is in a range of between 90:10 and 10:90.

9. The composite material according to claim 8, wherein the isocyanate characteristic of the reaction mixture lies in the range from 15 to 60.

10. The composite material according to claim 9, wherein the product of isocyanate functionality and functionality of the polyol component is at least 6.

11. The composite material according to claim 7, wherein the polyol component used in producing the polyurethane gel includes one or more polyols having a molecular weight (weight average) between 1,000 and 12,000 and an OH number in a range between 20 and 112, wherein the mathematical product of the functionalities of the polyurethane-forming components is at least 5.2 and the isocyanate characteristic is in a range between 15 and 60.

12. The composite material according to claim 7, wherein the isocyanates, used in producing the polyurethane gel, has a formula Q(NCO)ₙ, wherein n represents 2 to 4 and Q is selected from the group consisting of an aliphatic hydrocarbon radical having 6 to 18 C atoms, a cycloaliphatic hydrocarbon radical having 4 to 15 C atoms, an aromatic hydrocarbon radical having 6 to 15 C atoms or an araliphatic hydrocarbon radical having 8 to 15 C atoms.

13. The composite material according to claim 7, wherein the isocyanates are unmodified.

14. The composite material according to claim 7, wherein the isocyanates are urethanized.

15. The composite material according to claim 7, wherein the isocyanates are allophanatized.

16. The composite material according to claim 7, wherein the isocyanates are biuretized.

17. A molding made from a composite material comprising:
a polyurethane gel including coarse-grain solid particles distributed therein, selected from the group consisting of cork pieces, cork flour, wood pieces, wood chips, foam flakes, textile fibers and textile pieces, wherein the effective diameter of the coarse-grain solid particles is in a range between 0.1 mm to 15 mm.

18. A composite material comprising:
a polyurethane gel including coarse-grain solid particles selected from the group consisting of cork pieces, cork flour, wood pieces, wood chips, foam flakes, textile fibers and textile pieces distributed therein, wherein the effective diameter of the coarse-grain solid particles is in a range between 0.1 mm to 15 mm utilized in a product selected from the group consisting of shoes uppers, shoe insoles, mattresses, seat supports, seat cushions and carpet back coatings.
